(19) United States
(12) Patent Application Publication
(10) Pub. No.: US 2022/0369006 A1
(43) Pub. Date: Nov. 17, 2022

(54) RADIO FREQUENCY IDENTIFICATION AND QI WIRELESS POWER DEVICE

(71) Applicants: STMICROELECTRONICS LTD, Kowloon (HK); STMICROELECTRONICS (ROUSSET) SAS, Rousset (FR); STMicroelectronics Razvoj Polprevodnikov D.O.O., Ljubljana (SI)

(72) Inventors: Nicolas CORDIER, Aix-en-Provence (FR); Chia Hao CHEN, Taipei (TW); Karel BLAHA, Plzen (CZ)

(73) Assignees: STMICROELECTRONICS LTD, Kowloon (HK); STMICROELECTRONICS (ROUSSET) SAS, Rousset (FR); STMicroelectronics Razvoj Polprevodnikov D.O.O., Ljubljana (SI)

(21) Appl. No.: 17/735,968

(22) Filed: May 3, 2022

(30) Foreign Application Priority Data
May 11, 2021 (FR) 2104962

(51) Int. Cl. H04Q 9/06

(52) U.S. Cl. CPC H04Q 9/06

(57) ABSTRACT

Provided is a device comprising a frequency demodulator and an amplitude demodulator. The device is configured to use, in a first mode, both the frequency demodulator and the amplitude demodulator in parallel and to activate a radio frequency identification (RFID) card mode or a Qi charger mode based on results provided by said demodulators.

### BACKGROUND

### Technical Field

The present disclosure relates generally to electronic devices and more precisely to electronic devices integrating RFID (Radio Frequency Identification) technology.

### Description of the Related Art

Contactless technologies are very widespread and are widely used in transport and access control applications. The trend is to group, as much as possible, functionalities (traditionally hosted by contactless cards or IC cards) on a single device such as a mobile phone.

### BRIEF SUMMARY

There is a need to improve contactless access devices and more particularly access devices equipped with RFID technology.

One embodiment provides a device comprising a frequency demodulator and an amplitude demodulator, the device being configured to use, in a first mode, both demodulators in parallel and to activate an RFID card mode or a Qi charger mode based on results provided by said demodulators.

One embodiment provides a method implemented by a device comprising a frequency demodulator and an amplitude demodulator, in which the device uses, in a first mode, both demodulators in parallel and, in a second mode, both demodulators successively.

According to an embodiment, both frequency and amplitude demodulators also include load modulators/demodulators.

According to an embodiment, in a second mode, both frequency and amplitude demodulators operate successively.

According to an embodiment, a load modulator of the device is used when the device communicates with an external RFID A type apparatus configured in reader mode.

According to an embodiment, said load modulator is used when the device is charged by an external apparatus and when it emulates an RFID card configured in type A.

According to an embodiment, a Qi analog front end of the device is adapted to frequency modulate or amplitude modulate data when the device is in the second mode, the frequency modulated data being used to communicate with a Qi charger device and the amplitude modulated data being used to communicate with an RFID device configured in card mode.

According to an embodiment, the demodulator in amplitude is used to demodulate a response, in load modulation, of an external A type apparatus configured in card mode.

According to an embodiment, the amplitude demodulator is used to demodulate a command received from an external apparatus configured in reader mode.

According to an embodiment, the frequency demodulator is used to demodulate a response received from an external B type apparatus configured in card mode.

According to an embodiment, the frequency demodulator is used to demodulate a digital ping or any subsequent data packet received from an external charging apparatus.

According to an embodiment, the frequency demodulator is used to demodulate a response received from an external charge apparatus.

According to an embodiment, when it detects an external field on an antenna, checks whether that field comes from an RFID apparatus or from a Qi apparatus.

According to an embodiment, the check is made by emitting periodic interrogation frames in RFID mode and Qi mode.

### BRIEF DESCRIPTION OF THE SEVERAL VIEWS OF THE DRAWINGS

The foregoing features and advantages, as well as others, will be described in detail in the following description of specific embodiments given by way of illustration and not limitation with reference to the accompanying drawings, in which:

FIG. 1 schematically shows an example of a communication system comprising a device including the Qi technology, to which apply, by way of example, embodiments described;

FIG. 2 shows a timing diagram illustrating an operating mode of the device illustrated in FIG. 1;

FIG. 3 shows a flowchart illustrating a part of the timing diagram illustrated in FIG. 2;

FIG. 4 shows an example of a part of the timing diagram illustrated in FIG. 2;

FIG. 5 shows a block diagram of an embodiment of the communication circuit of the device illustrated in FIG. 1;

FIG. 6 shows a first example of operation of the circuit illustrated in FIG. 5;

FIG. 7 shows another example of a part of the timing diagram illustrated in FIG. 2;

FIG. 8 shows a second example of operation of the circuit illustrated in FIG. 5;

FIG. 9 shows another example of a part of the timing diagram illustrated in FIG. 2;

FIG. 10 shows a third example of operation of the circuit illustrated in FIG. 5;

FIG. 11 shows a fourth example of operation of the circuit illustrated in FIG. 5;

FIG. 12 shows a fifth example of operation of the circuit illustrated in FIG. 5;

FIG. 13 shows a sixth example of operation of the circuit illustrated in FIG. 5; and

FIG. 14 shows another example of a part of the timing diagram illustrated in FIG. 2.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, the circuits which are qualified by their respective functions are not structurally detailed.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front,” “back,” “top,” “bottom,” “left,” “right,” etc., or to relative positional qualifiers, such as the terms “above,” “below,” “higher,” “lower,” etc., or to qualifiers of orientation, such as “horizontal,” “vertical,” etc., reference is made to the orientation shown in the figures.

Unless specified otherwise, the expressions “around,” “approximately,” “substantially” and “in the order of” signify within 10%, and preferably within 5%.

In the present description, it is proposed to take advantage of the fact that Qi technology (which corresponds to a standard developed by the Wireless Power Consortium for the transmission of wireless energy) is very widely developed in new models of smartphones. Qi technology is particularly interesting because it works for a frequency band including the Low Frequency (LF) (100 kHz to 200 kHz). In the present description, it is thus sought to establish LF communications by RFID technology by using some of the components of the circuit dedicated to the Qi technology.

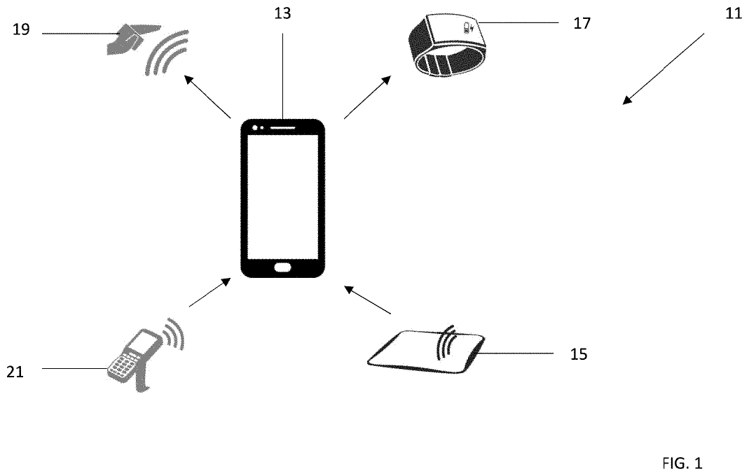

FIG. 1 schematically shows an example of a communication system comprising a device including the Qi technology, to which apply, by way of example, the disclosed embodiments.

The system 11 illustrated in FIG. 1 comprises an electronic device 13 adapted to communicate with other electronic apparatuses/devices with Qi technology and with RFID technology.

According to an embodiment, the device 13 is a mobile phone, for example a smartphone, or a tablet computer.

According to the embodiment illustrated in FIG. 1, the device 13 is adapted to be charged by a Qi charger platform 15 (chargeable mode) or to charge another electronic apparatus 17 equipped with the Qi technology (charger mode). In other words, the device 13 is adapted, depending on its external environment, to switch from a charger mode to a chargeable mode. The device 13 can then operate in charger mode and charge an apparatus present in its environment, or in chargeable mode and be charged by a charger apparatus present in its environment.

According to the embodiment illustrated in FIG. 1, the device 13 is also adapted to communicate with an RFID apparatus configured in card mode 19 and an RFID apparatus configured in reader mode 21. In other words, the device 13 is adapted, depending on its external environment, to switch from a reader mode to a card mode. The device 13 can then operate in reader mode and communicate with an apparatus in card mode present in its environment, or in card mode and communicate with an apparatus in reader mode present in its environment.

According to an application example, the embodiments apply to transport systems and to access control, for example, to doors of buildings equipped with Low Frequency (LF) technology.

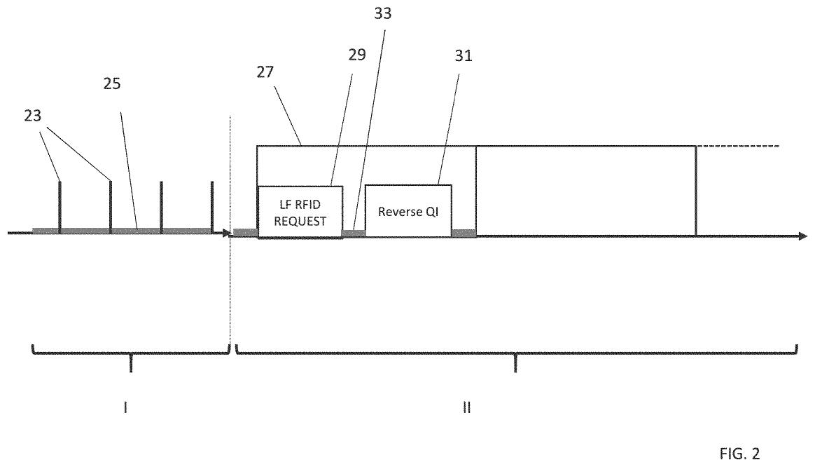

FIG. 2 represents a timing diagram illustrating an operating mode of the device illustrated in FIG. 1.

When the device 13 illustrated in FIG. 1 is not communicating, it is in low power mode or standby, in order to reduce the power consumption.

When the device 13 is in standby, it should still be capable of detecting the presence of an RFID reader, an RFID card, a chargeable apparatus or a charger apparatus.

The timing diagram illustrated in FIG. 2 comprises two successive parts I and II, part I corresponding to an operation when the device 13 is in standby mode and part II corresponding to an operation when the device 13 is in normal mode called polling mode.

According to the embodiment illustrated in FIG. 2, when the device 13 is in standby mode (part I), it “probes” its environment by short periodic emission pulses 23. Two pulses 23 are, by example, separated by a time interval 25. A pulse 23 corresponds to a short field emission by the device 13 to detect a possible apparatus configured in card mode or a chargeable apparatus present in its field. In the event of such detection, the device 13 then wakes from standby and switches to normal mode (part II). The detection implements an analysis of the electrical quantities specific to these pulses 23 such as amplitude or phase, these quantities varying if an apparatus configured in card mode or a chargeable apparatus is nearby.

During intervals 25, the device 13 is in listener mode for apparatuses in reader mode or charger apparatuses within range.

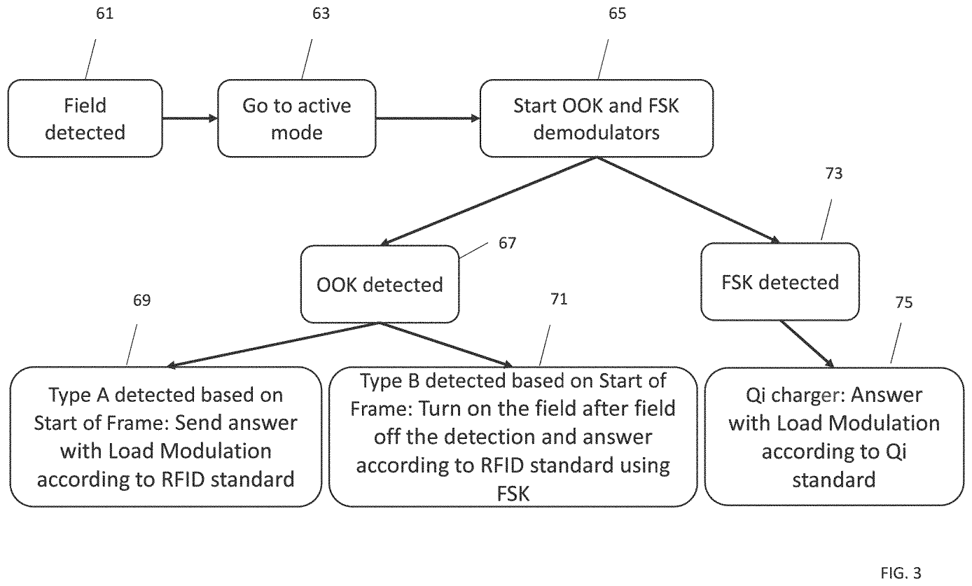

FIG. 3 represents a flowchart illustrating a part of the timing diagram illustrated in FIG. 2. More precisely, the flowchart corresponds to an example of implementation of listener mode.

In case the device 13 detects a field (block 61, Field detected), it activates (block 63, Go to active mode), by exiting the standby mode and responds to the reader or charger apparatus depending on the detected technology.

More precisely, the device 13 comprises two demodulators, one demodulator adapted to demodulate an On-Off Keying (OOK) modulation and one demodulator adapted to demodulate a Frequency Shift Keying (FSK) modulation. The device 13 is in normal mode when both demodulators are started (block 65, Start OOK and FSK demodulators).

In order to respond to the reader or charger apparatus, the device 13 detects the technology of the apparatus within the range, and more precisely the type of modulation it is based on. Thus, the device 13 detects the On-Off Keying (OOK) modulation (block 67, OOK detected) or the Frequency Shift Keying (FSK) modulation (block 73, FSK detected).

The response of the device 13 is adapted to the detected modulation type of the apparatus.

If a type A is detected, based on start of frame, in addition to the OOK modulation, the device 13 responds by sending an answer with a load modulation according to RFID standard (block 69, Type A detected based on Start of Frame: Send answer with Load Modulation according to RFID standard).

If a type B is detected, based on start of frame, in addition to the OOK modulation, the device 13 responds by turning on the field after field off the detection and by answering according to RFID standard using FSK modulation (block 71, Type B detected based on Start of Frame: Turn on field after field off detection and answer according to RFID standard using FSK).

If a FSK modulation is detected, the device 13 responds by answering with the load modulation according to Qi standard (block 75, Qi charger: Answer with Load Modulation according to Qi standard).

According to the embodiment illustrated in FIG. 2, in normal mode (part II), the device 13 emits periodic interrogation frames 27, during which it generates a field intended for card mode apparatuses or chargeable apparatuses within range. The interrogation frame 27 can be repeated several times before going back to standby mode in case any card mode apparatuses answered. The aim of these periodic frames (polling loop) is to determine the type of external apparatus based on the type of emitted frames to which this external apparatus respond.

A frame 27 is, for example, made up of a succession of two emission bursts 29 and 31, burst 29 (LF RFID REQUEST) being configured to generate a field understandable by card mode apparatuses and burst 31 (Reverse Qi) being configured to generate a field understandable by chargeable apparatuses.

In other words, during a frame 27, the device 13 successively implements two emission bursts 29 and 31 each representative of a type of technology (Qi or RFID). The types of technologies targeted by the bursts are successively RFID technology and Qi technology.

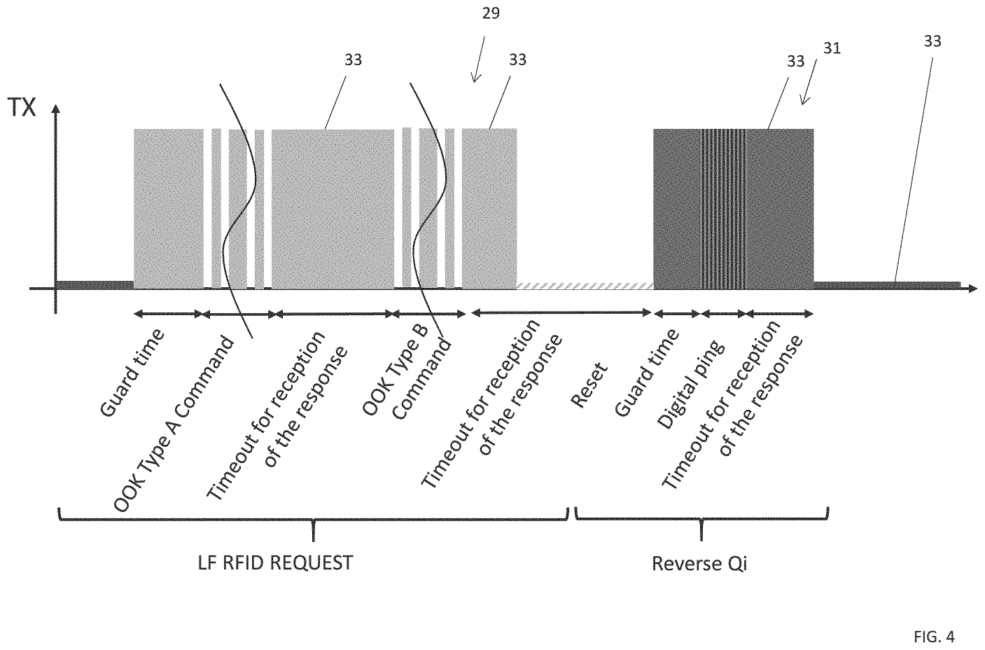

FIG. 4 represents an example of expansion of part of the timing diagram illustrated in FIG. 2. More precisely, FIG. 4 represents a timing diagram of a frame 27.

According to the embodiment illustrated in FIG. 4, the burst 29 comprises a guard time (Guard time) followed by two successive requests each representative of type A or type B. Each of the first request (OOK Type A Command) and the second request (OOK Type B Command) are followed by a waiting time 33 (Timeout for reception of the response). During the waiting time 33 the device 13 waits for the response of type A card mode apparatuses in its field or type B card mode apparatuses.

According to the embodiment illustrated in FIG. 4, the burst 29 and the burst 31 are separated by a reset time (Reset).

According to the embodiment illustrated in FIG. 4, the burst 31 comprises a guard time (Guard time) followed by one request representative of the Qi technology (Digital ping). The request is followed by a waiting time 33 (Timeout for reception of the response). During the waiting time 33 the device 13 waits for the response of apparatuses to charge in its field.

According to the embodiment illustrated in FIG. 4, before the burst 29, between bursts 29 and 31, and after the burst 31, the device 13 is in listener mode.

According to one embodiment, each pulse 23 has a duration of between 50 microseconds (μs) and 100 μs, for example of the order of 70 μs and each burst 29, 31 has a duration of between 50 milliseconds (ms) and 100 ms, for example of the order of 70 ms. The interval 25 and the wait time 33 have a duration of between 200 ms and 1 s.

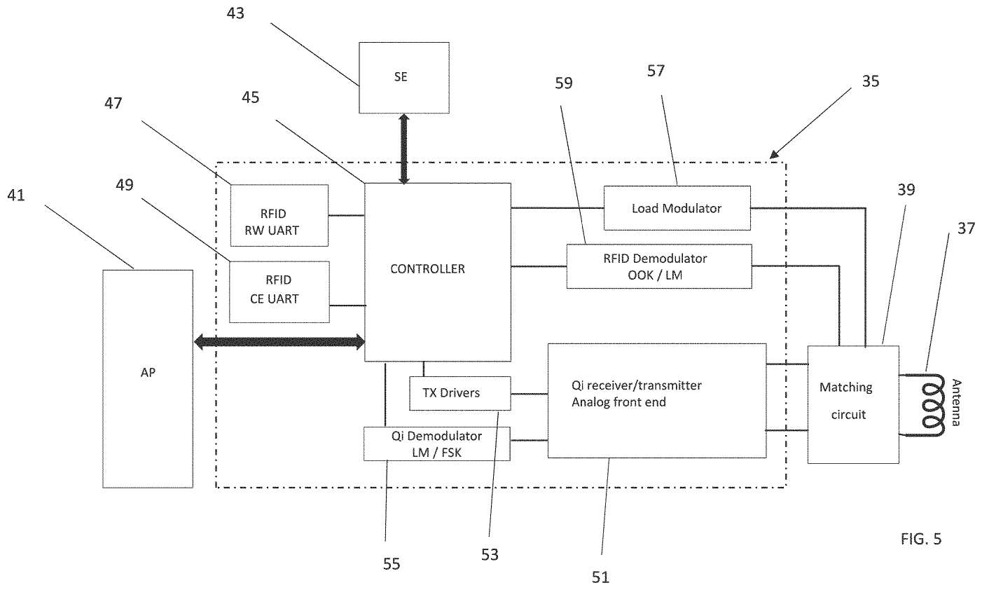

FIG. 5 represents, schematically and in the form of blocks, an embodiment of the communication circuit 35 of the device 13 illustrated in FIG. 1.

The communication circuit 35 is coupled to an antenna 37 (Antenna) via matching circuit 39 (Matching circuit). The communication circuit 35 can also be coupled to an application processor 41 (AP) and/or to a secure element 43 (SE).

According to the embodiment shown in FIG. 3, the communication circuit 35 comprises:
a controller 45 (CONTROLLER), for example, a microcontroller or microprocessor for managing the exchanges between the different elements of the circuit 35;
an RFID reader wireless receiver/transmitter 47 (RFID RW UART) coupled to the controller 45 for coding/decoding data in reader mode;
an RFID card emulation receiver/transmitter 49 (RFID CE UART) coupled to the controller 45 for coding/decoding data in card mode;
a Qi receiver/transmitter analog front end 51 (Qi receiver/transmitter Analog font end) coupled to the matching circuit 39, for shaping the signals received and to be transmitted;
a transmission/emission circuit 53 (TX Drivers) for amplifying, in emission, the signals provided by the controller 45 to the Qi analog front end 51;
a frequency demodulator and load modulation demodulator (also called backscattering) 55 (Qi Demodulator LM/FSK), between the Qi analog front end 51 and the controller 45, for frequency demodulating the signal received by the Qi analog front end 51;
a load modulator 57 (Load Modulator), between the controller 45 and the matching circuit 39, to impact an external field in RFID card mode or in Qi charger mode; and
an amplitude demodulator and load modulation demodulator 59 (RFID Demodulator OOK/LM), between the matching circuit 39 and the controller 45, adapted to demodulate the received signal in respectively RFID card and reader modes.

According to an embodiment, the controller 45 comprises coding circuits dedicated to the Qi technology.

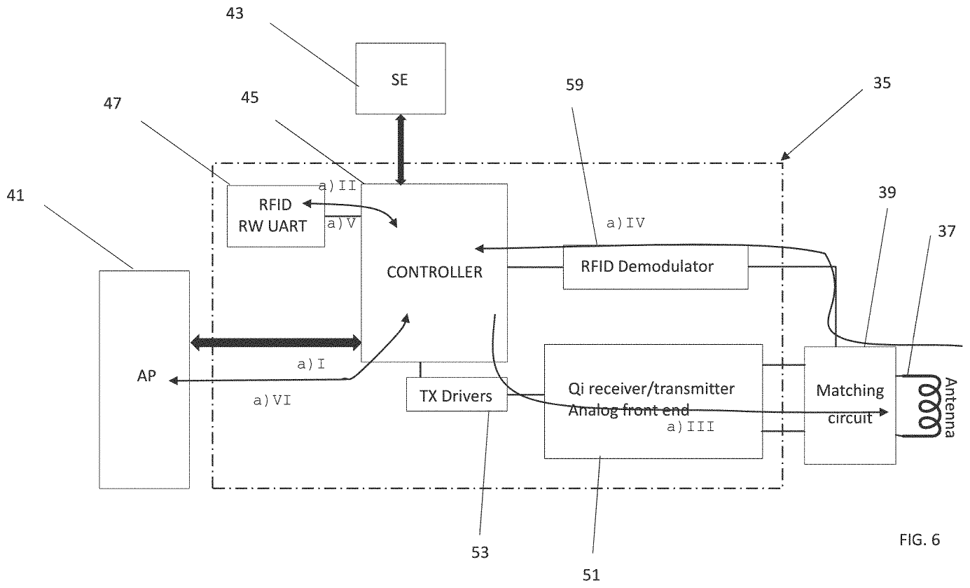

FIGS. 6 to 14 show six examples of operating process of the circuit 35 depending on the external apparatus that it detects or that detects it. In each of FIGS. 6 to 14, the components not being solicited during the illustrated example of use have not been shown.

FIG. 6 illustrates circuit 35 while device 13 detects and communicates, in reader mode, with an LF apparatus of type A configured in card mode.

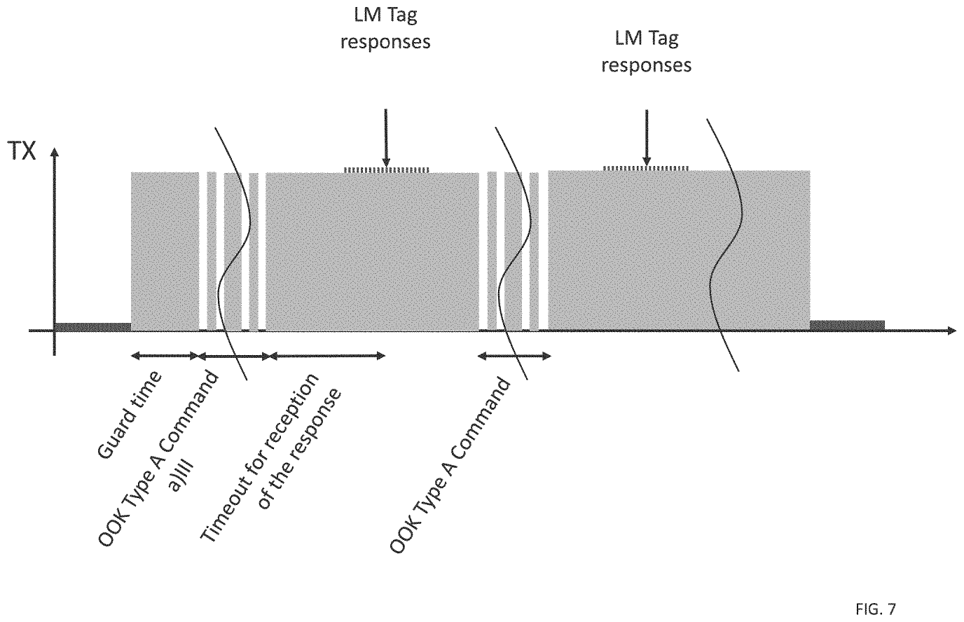

FIG. 7 represents a time diagram of an example of frame 27 in the circuit 35 of FIG. 6.

According to the embodiment illustrated in FIGS. 6 and 7, when the device 13 detects an external type A apparatus configured in card mode and communicating in Low Frequency (LF), the device 13 operates in reader mode.

In such a mode, the application processor runs (link a)I) the Low frequency RFID reader wireless application using the controller 45.

The controller 45 uses the RFID reader wireless receiver/transmitter 47 to construct the low frequency RFID reader wireless commands or LF RFID RW commands (link a)II).

The controller 45 uses the TX drivers 53 and the analog front end 51 to generate the LF RFID RW commands according to the A type, using an On-Off Keying modulation (OOK Type A command a)III, FIG. 7) (link a)III).

The responses (LM Tag responses, FIG. 7) from the external apparatus in card mode to the device 13 are demodulated using a load demodulation via the RFID Demodulator 59 (link a)IV).

According to an embodiment, not shown, the responses from the external apparatus in card mode to the device 13 are demodulated by the Qi Demodulator 55.

The controller 45 then uses the RFID reader wireless coder/decoder 47 to decode the external apparatus in card mode responses (link a)V) and to forward the corresponding data to the application processor 41 (link a)VI).

During this operating process, the controller 45 may use the secure element 43 to perform any required cryptographic operation.

After establishing contact between the device 13 and the apparatus within the range, they both communicate by sending successive commands and responses.

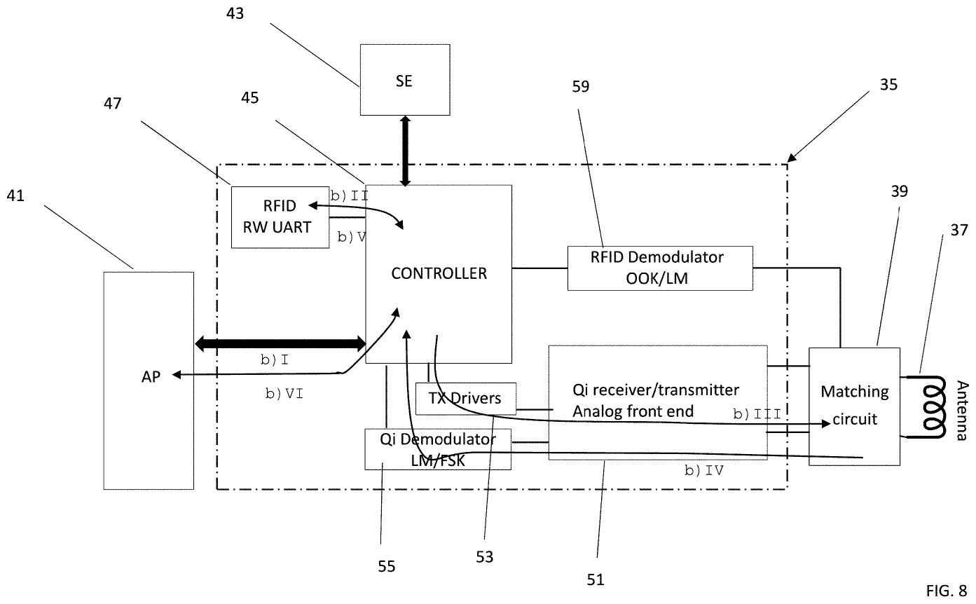

FIG. 8 illustrates circuit 35 while device 13 detects and communicates, in reader mode, with an LF apparatus of type B configured in card mode.

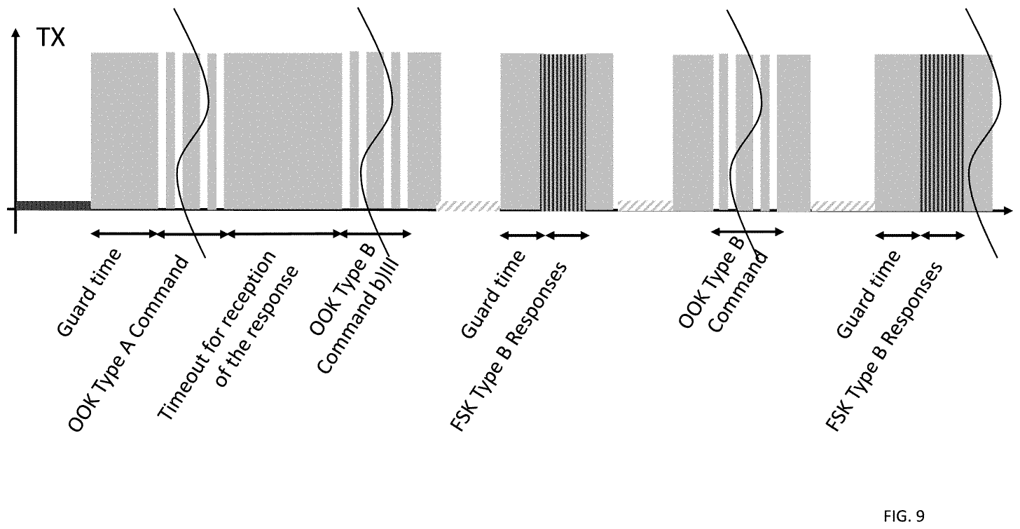

FIG. 9 represents a time diagram of an example of frame 27 in the circuit 35 of FIG. 8.

According to the embodiment illustrated in FIG. 8, the detection of an external B type apparatus configured in card mode is made after a lack of response to a request in A type.

According to the embodiment illustrated in FIG. 8, when the device 13 detects an external type B apparatus configured in card mode and communicating in LF, the device 13 operates in reader mode.

In such a mode, the application processor runs (link b)I) the Low frequency RFID reader wireless application using the controller 45.

The controller 45 uses the RFID reader wireless receiver/transmitter 47 to build the Low frequency RFID reader wireless commands or LF RFID RW commands (link b)II).

The controller 45 uses the TX drivers 53 and the analog front end 51 to generate the LF RFID RW commands according to the B type, by the generation of a magnetic field, using an On-Off keying amplitude modulation (OOK Type B Command b)III, FIG. 9) (link b)III).

After generating the command, the device 13 stop its magnetic field and wait for an answer from the external apparatus.

The responses from the external apparatus in card mode to the device 13 (FSK Type B Responses, FIG. 9) are demodulated using a frequency shift keying demodulation (FSK demodulation) via the Qi demodulator 55 (link b)IV).

The controller 45 then uses the RFID reader wireless receiver/transmitter 47 to decode the external apparatus in card mode responses (link b)V) and to forward the corresponding data to the application processor 41 (link b)VI).

During this operating process, the controller 45 may use the secure element 43 to perform any required cryptographic operation.

After establishing contact between the device 13 and the apparatus within the range, they both communicate by sending successive commands and responses.

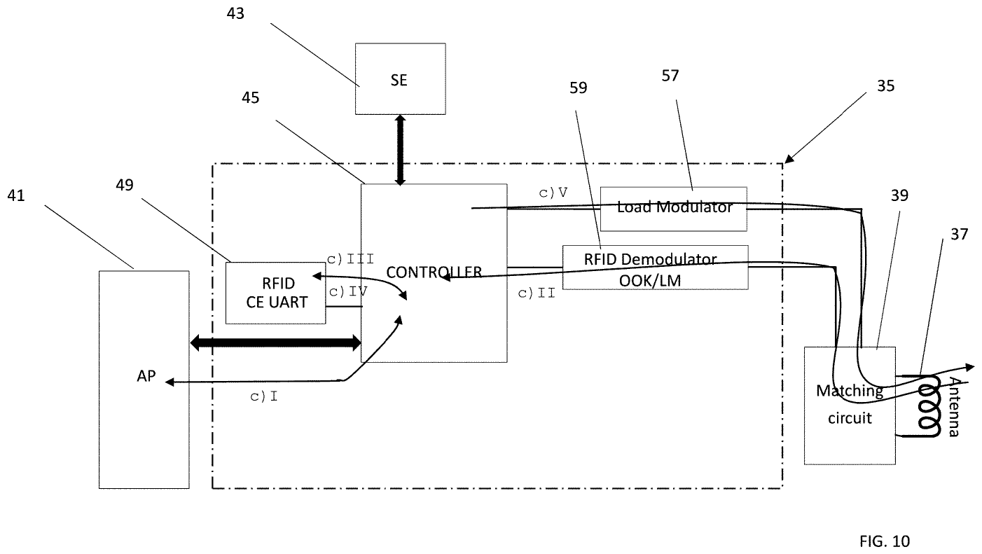

FIG. 10 illustrates circuit 35 while device 13 detects and communicates, in card mode, with an LF apparatus of type A configured in reader mode.

According to the embodiment illustrated in FIG. 10, when the device 13 detects an external type A apparatus configured in reader mode and communicating in LF, the device 13 operates in card mode.

In such a mode, the application processor runs (link c)I) the Low frequency RFID card emulation application using the controller 45.

The commands from the external apparatus in reader mode to the device 13 are demodulated via the RFID demodulator 59 (link c)II), using an on-off keying amplitude demodulation.

The controller 45 then uses the RFID card emulation coder/decoder 49 to decode the external apparatus commands (link c)III) and uses the RFID card emulation coder/decoder 49 to build the responses (link c)IV).

The controller 45 uses the load modulator 57 to generate the response according to the A type with the apparatus in reader mode via the matching circuit 39, using a load modulation (link c)V).

During this operating process, the controller 45 may use the secure element 43 to perform any required cryptographic operation.

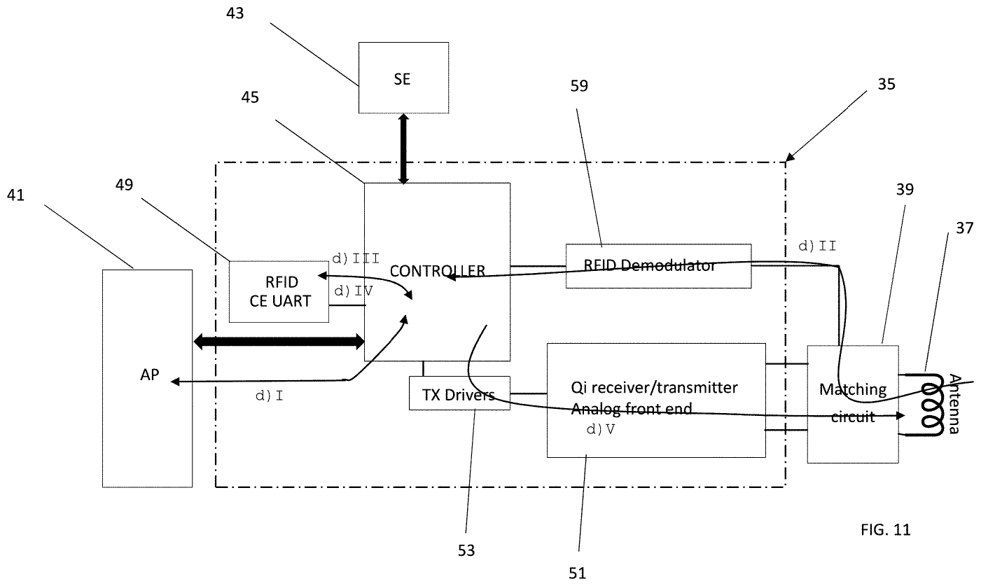

FIG. 11 illustrates circuit 35 while device 13 detects and communicates, in card mode, with an LF apparatus of type B configured in reader mode.

According to the embodiment illustrated in FIG. 11, when the device 13 detects an external type B apparatus configured in reader mode and communicating in LF, the device 13 operates in card mode.

In such a mode, the application processor runs (link d)I) the Low frequency RFID card emulation application using the controller 45.

The commands from the external apparatus in reader mode to the device 13 are demodulated using an on-off keying demodulation via the RFID demodulator 59 (link d)II).

The controller 45 then uses the RFID card emulation coder/decoder 49 to decode the external apparatus commands (link d)III) and uses the RFID card emulation coder/decoder 49 to build the responses (link d)IV).

The controller 45 uses the TX drivers 53 and the analog front end 51 to generate the response according to the B type with the apparatus in reader mode via the matching circuit 39, using an Frequency-Shift Keying modulation (FSK modulation) (link d)V).

During this operating process, the controller 45 may use the secure element 43 to perform any cryptographic operation required.

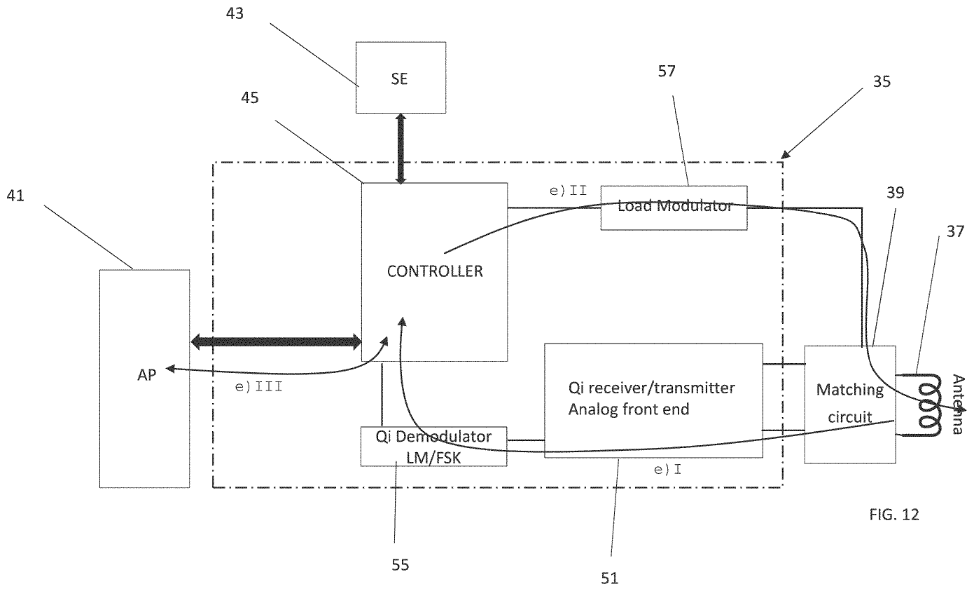

FIG. 12 illustrates circuit 35 while device 13 detects and is charged by a charger apparatus.

According to the embodiment illustrated in FIG. 12, when the device 13 detects an external charger Qi apparatus, the device 13 operates in chargeable mode.

In such a mode, the Qi analog ping from the external apparatus in charger mode to the device 13 is demodulated, using an FSK demodulation via the Qi demodulator 55 and decoded by the controller 45 (link e)I).

The controller 45 uses the load modulator 57 to generate the responses via the matching circuit 39 (link e)II).

Then, the device 13 is being charged and the controller 45 communicates monitoring data to the application processor 41 (link e)III).

During this operating process, the controller 45 may use the secure element 43 in case it is needed to perform an authentication.

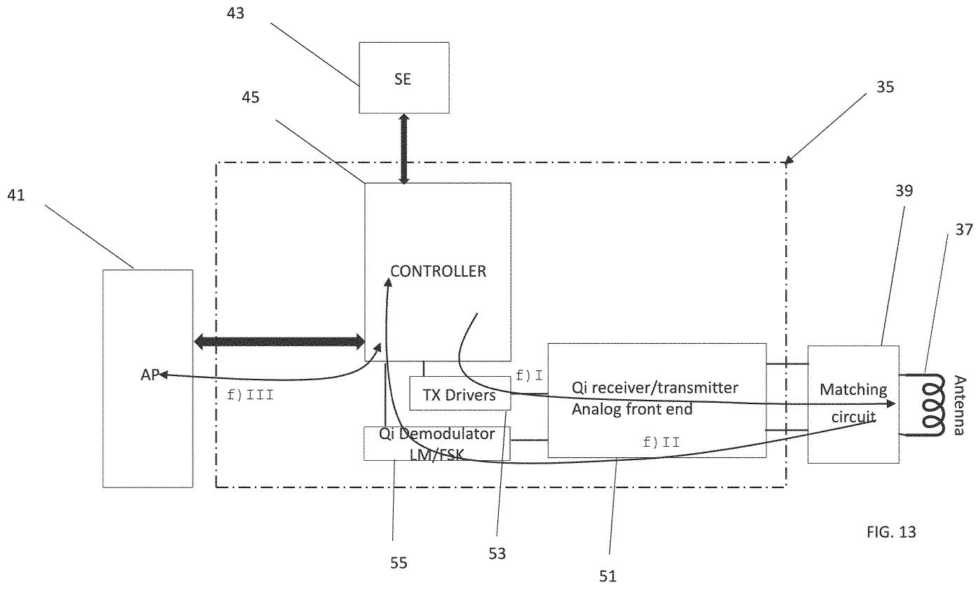

FIG. 13 illustrates circuit 35 while device 13 detects and charges a chargeable apparatus.

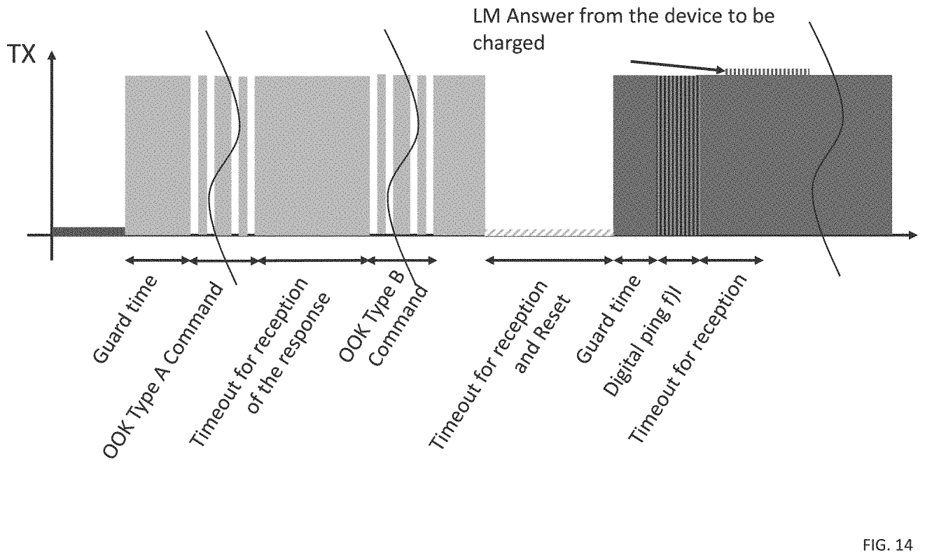

FIG. 14 represents a time diagram of an example of frame 27 in the circuit 35 of FIG. 13.

According to the embodiment illustrated in FIGS. 13 and 14, the detection of a chargeable apparatus is made after a lack of response to an RFID request (frame 27).

According to the embodiment illustrated in FIG. 13, when the device 13 detects an external Qi apparatus in chargeable mode, the device 13 operates in charger mode.

In such a mode, the controller 45 sends, using an FSK modulation (link f)I) the digital Qi ping (Digital ping f)I, FIG. 14) using the TX Drivers 53.

The response from the external apparatus (LM Answer from the device to be charged, FIG. 14) is demodulated using a load demodulator 55 via the Qi demodulator 51 (link f)II) and decoded by the controller (link f)III).

Then, the device 13 charges the apparatus within range and the controller 45 communicates monitoring data to the application processor 41 (link f)III).

During this operating process, the controller 45 may use the secure element 43 in case it is needed to perform an authentication.

After establishing contact between the device 13 and the apparatus within the range, they both communicate by sending successive commands and responses. Any subsequent data packet received from an external charger apparatus can then be demodulated by the load demodulator 55.

According to the disclosed embodiments, during phase I illustrated in FIG. 2, the device 13 is adapted to use the Qi demodulator and the RFID demodulator in parallel, while during phase II, the device 13 is adapted to use the Qi demodulator and the RFID demodulator successively.

An advantage of the described embodiments is that they make it possible to combine, within the same circuit, RFID LF and Qi technologies.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

Device may be summarized as including a frequency demodulator (55) and an amplitude demodulator (59), the device being configured to use, in a first mode (I), both demodulators in parallel and to activate an RFID card mode or a Qi charger mode based on results provided by said demodulators.

A method implemented by a device may be summarized as including a frequency demodulator (55) and an amplitude demodulator (59), in which the device uses, in a first mode (I), both demodulators in parallel and, in a second mode (II), both demodulators successively.

Both frequency and amplitude demodulators also may include load modulators/demodulators.

In a second mode, both frequency and amplitude demodulators may operate successively.

A load modulator (57) of the device may be used when the device communicates with an external RFID A type apparatus configured in reader mode.

Said load modulator (57) may be used when the device is charged by an external apparatus and when it emulates an RFID card configured in type A.

A Qi analog front end (51) of the device may be adapted to frequency modulate or amplitude modulate data when the device is in the second mode, the frequency modulated data being used to communicate with a Qi charger device and the amplitude modulated data being used to communicate with an RFID device configured in card mode.

The demodulator in amplitude (59) may be used to demodulate a response, in load modulation, of an external A type apparatus configured in card mode.

The amplitude demodulator (59) may be used to demodulate a command received from an external apparatus configured in reader mode.

The frequency demodulator (55) may be used to demodulate a response received from an external B type apparatus configured in card mode.

The frequency demodulator (55) may be used to demodulate a digital ping or any subsequent data packet received from an external charging apparatus.

The frequency demodulator (55) may be used to demodulate a response received from an external charge apparatus.

When it detects an external field on an antenna, may check whether that field comes from an RFID apparatus or from a Qi apparatus.

The check may be made by emitting periodic interrogation frames in RFID mode and Qi mode.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device comprising:
a frequency demodulator configured to provide a first demodulation result; and
an amplitude demodulator configured to provide a second demodulation result, wherein:
the device is configured to:
use, in a first mode, the frequency demodulator and amplitude demodulator in parallel; and
activate a radio frequency identification (RFID) card mode or a Qi charger mode based on the first and second demodulation results.

2. The device according to claim 1, wherein the device uses, in a second mode, the frequency demodulator and the amplitude demodulator successively.

3. The device according to claim 1, wherein the frequency demodulator includes a load modulator or demodulator, and the amplitude demodulator includes a load modulator or demodulator.

4. The device according to claim 1, comprising:
a load modulator, wherein the device uses the load modulator in response to the device communicating with an external RFID A type apparatus configured in reader mode.

5. The device according to claim 4, wherein the load modulator is used in response to the device being charged by an external apparatus and when the device emulating an RFID card configured in type A.

6. The device according to claim 1, comprising:
a Qi analog front end configured to frequency modulate frequency modulated data or amplitude modulate amplitude modulated data in response to the device being in the second mode, the frequency modulated data being used to communicate with a Qi charger device and the amplitude modulated data being used to communicate with an RFID device configured in card mode.

7. The device according to claim 1, wherein the amplitude demodulator is configured to demodulate a response of an external A type apparatus configured in card mode.

8. The device according to claim 1, wherein the amplitude demodulator is configured to demodulate a command received from an external apparatus configured in reader mode.

9. The device according to claim 1, wherein the frequency demodulator is configured to demodulate a response received from an external B type apparatus configured in card mode.

10. The device according to claim 1, wherein the frequency demodulator is configured to demodulate a digital ping or a subsequent data packet received from an external charging apparatus.

11. The device according to claim 1, wherein the frequency demodulator is configured to demodulate a response received from an external charge apparatus.

12. The device according to claim 1, comprising:
an antenna, wherein the device, in response to detecting an external field on the antenna, checks whether the field is generated by an RFID apparatus or a Qi apparatus.

13. The device according to claim 12, wherein the device checks whether the field is generated by the RFID apparatus depending on whether a type of modulation is amplitude modulation or frequency modulation.

14. A method comprising:
providing, by a frequency demodulator of a device, a first demodulation result;
providing, by an amplitude demodulator of the device, a second demodulation result;
using, in a first mode, the frequency demodulator and amplitude demodulator in parallel; and
activating a radio frequency identification (RFID) card mode or a Qi charger mode based on the first and second demodulation results.

15. The method according to claim 14, comprising:
using the frequency demodulator and the amplitude demodulator successively in a second mode.

16. The method according to claim 14, wherein the frequency demodulator includes a load modulator or demodulator, and the amplitude demodulator includes a load modulator or demodulator.

17. The method according to claim 14, comprising:
using a load modulator in response to communicating with an external RFID A type apparatus configured in reader mode.

18. The method according to claim 17, comprising:
using the load modulator in response to the device being charged by an external apparatus and in response to the device emulating an RFID card configured in type A.

19. The method according to claim 14, comprising:
frequency modulating frequency modulated data or amplitude modulating amplitude modulated data in response to the device being in the second mode, the frequency modulated data being used to communicate with a Qi charger device and the amplitude modulated data being used to communicate with an RFID device configured in card mode.

20. The method according to claim 14, wherein the amplitude demodulator is configured to demodulate a response of an external A type apparatus configured in card mode.

21. The method according to claim 14, wherein the amplitude demodulator is configured to demodulate a command received from an external apparatus configured in reader mode.

22. The method according to claim 14, wherein the frequency demodulator is configured to demodulate a response received from an external B type apparatus configured in card mode.

23. The method according to claim 14, wherein the frequency demodulator is configured to demodulate a digital ping or a subsequent data packet received from an external charging apparatus.

24. The method according to claim 14, wherein the frequency demodulator is configured to demodulate a response received from an external charge apparatus.

25. The method according to claim 14, comprising:
in response to detecting an external field on an antenna, checking whether the field is generated by an RFID apparatus or a Qi apparatus.

26. The method according to claim 25, comprising:
emitting periodic interrogation frames to detect whether the RFID apparatus or the Qi apparatus available for charging is in range.

27. The method according to claim 14, comprising:
detecting, while operating in a low power mode, an RFID apparatus or a Qi apparatus;
in response to detecting the RFID apparatus or the Qi apparatus, transitioning to a polling mode; and
determining, in the polling mode, whether the RFID apparatus or the Qi apparatus is in range.
